(19) United States
(12) Patent Application Publication
(10) Pub. No.: US 2022/0031121 A1
(43) Pub. Date: Feb. 3, 2022

(54) Device And Method To Warm Food Over An Open Flame

(71) Applicants: Craig Steven Knoener, Appleton, WI (US); Andrew James Thielke, Kaukauna, WI (US); Milad Pashapour Nikou, Manlius, NY (US)

(72) Inventors: Craig Steven Knoener, Appleton, WI (US); Andrew James Thielke, Kaukauna, WI (US); Milad Pashapour Nikou, Manlius, NY (US)

(21) Appl. No.: 16/947,447

(22) Filed: Jul. 31, 2020

(51) Int. Cl. A47J 43/18; A47J 43/28; A47J 37/07

(52) U.S. Cl. CPC A47J 43/18; A47J 37/0786; A47J 43/283

(57) ABSTRACT

Devices and methods to heat food over an open flame are disclosed. An example food warming device includes a fork and pan used together to evenly distribute heat into solid food, minimize direct heat from the flame to the food, and reduce the chance of igniting the food.

### BACKGROUND

This disclosure relates generally to devices to warm food over an open flame.

Conventional devices used to warm food over an open flame place the food on a stick which is used over the open flame. This makes it difficult to evenly heat the food resulting in the food being undercooked in its center or over cooked on its surface. Maintaining the distance from the food to the moving flame is challenging; rotating the food at the same time often results in poor quality. Certain foods may also catch fire when placed directly above an open flame. For example, a supervised child toasting a marshmallow over a campfire almost certainly results in a flaming marshmallow; even adults with sufficient marshmallow toasting experience often have similar results.

### SUMMARY

A device to warm food over an open flame is disclosed, substantially as illustrated by and described in connection with at least one of the figures, as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 is a view of the pan and fork of an example implementation of the food warming device.

FIG. 2 is a view of the pan of an example implementation of the food warming device before the pan is formed.

FIG. 3 is a view of the pan and fork of an example implementation of the food warming device showing the pan rotated away from the tines of the fork.

FIG. 4 is a view of the pan and food of an example implementation of the food warming device showing how heat is transferred from the flame to the food.

The figures are not necessarily to scale. Where appropriate, similar or identical reference numbers are used to refer to similar or identical components.

### DETAILED DESCRIPTION

Disclosed are examples of devices to warm food over an open flame.

As used herein, the term “pan” refers to a metal structure that is placed between the food and the open flame. The pan may be formed in different manners and not limited to the explained. For example, the pan may first be laser cut and/or stamped followed by folding and/or riveting or spot welding. The pan may have many different shapes and not limited to the explained. The pan may be a simple rigid flat sheet, a half cylinder, or the pan may be a complicated structure with contoured sides and a top with hinges and complicated fold lines.

As used herein, the term “fork” refers to a structure that supports food over a flame and is long enough so a person can place and remove food over a flame from a safe distance from the flame. The fork may have one or more tines at the end of the fork where the food is secured. The fork may have a handle that is made of a different material that limits thermal conduction from the fork to the user's hand.

As used herein, the phrase “legs” refers to elements attached to the bottom of the pan to stand the pan above the open flame instead of the user supporting the pan with the fork. Examples, but not limited to, are stainless steel rods. The pan may be constructed from an aluminum alloy and the legs constructed from stainless steel alloy.

As used herein, the phrase “solid food” is any food that can be supported on the fork. Examples, but not limited to, are marshmallows, hot dogs, bratwurst, bacon, bread and pastry dough.

As used herein, the phrase “liquid food” is anything contained in the pan used to warm the solid food. Examples, but not limited to, are water, oil, beer and coffee.

As used herein, the phrase “fuel” is a material that is burned to produce heat for the solid food or liquid food. The fuel may be solid, liquid or gaseous. Examples, but not limited to, are wood, paper, cardboard, methane or propane.

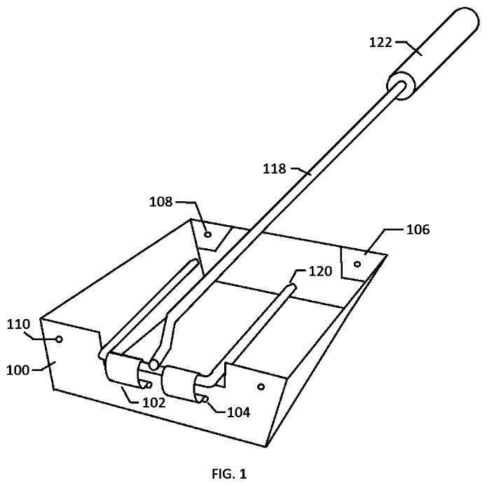

FIG. 1 is an example implementation of the food warming device.

Referring to FIG. 1, there is shown an example pan 100 attached to a fork 118. The fork 118 is a rigid structure with a handle 122 on one end and tines 120 on the other end. The tines 120 may face in any direction in relation to the handle 122. The solid food may be placed on one or more of the tines 120. Liquid food is placed in the pan 100. The fork 118 is attached to the pan 100 with a hinge. The hinge may be created by bending hinge tabs 102 of the pan 100 around the fork 118 and through the hinge slots 104 in the pan 100; intentionally making the fork 118 difficult to separate from the pan 100. The hinge may be created by bending the hinge tabs 102 of the pan 100 around the fork 118, but not through the hinge slots 104; this allows the fork 118 to be easily separated from the pan 100. The pan 100 has corner tabs 106 used to hold the side of the pan in place. The sides of the pan 100 are held together with rivets that are placed through pan rivet holes 110 and corner tab holes 108.

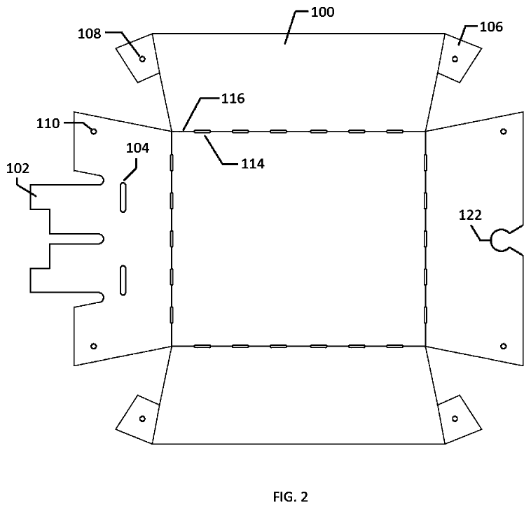

FIG. 2 is an example implementation of the food warming device before the pan 100 is formed.

Referring to FIG. 2, the pan 100 may have perforations 114 to improve the bending of the pan 100 at the bending lines 116. The pan 100 may not have perforations 114 if liquid is to be used in the pan 100. The edges of the pan 100 that are not folded may be rolled to prevent a sharp edge. The pan 100 may include a locking feature 122 that allows the pan 100 to securely attach the pan 100 to the fork 118 on the side of the pan 100 opposite of the hinge.

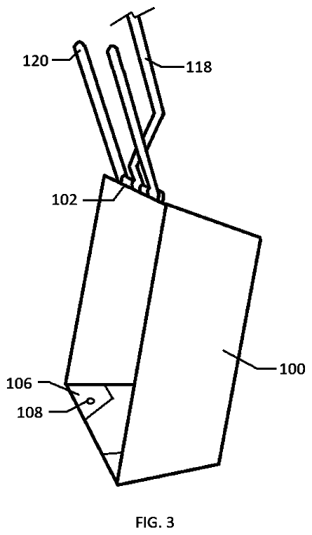

FIG. 3 is an example implementation of the food warming device showing the pan 100 rotated away from the tines 120 of the fork 118.

Referring to FIG. 3, the hinge created by bending hinge tabs 102 of the pan 100 around the fork 118 and through the hinge slots 104 in the pan 100 allows the pan 100 to rotate away from the tines 120 of the fork 118. The hinge allows the user to easily and quickly remove the solid food from the tines 120 and place solid food on the tines 120. The hinge tabs 102 allow the user to attach and detach the pan 100 from the fork 118.

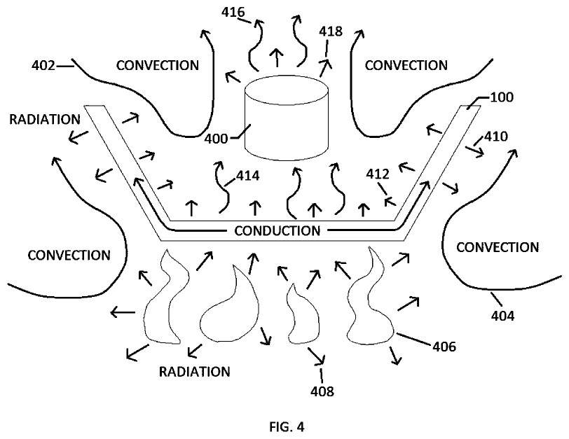

FIG. 4 is an example implementation of the food warming device showing how heat is transferred from the flame to the food.

Referring to FIG. 4, the transfer of heat with radiation is shown as straight segments with arrow heads and the transfer of heat with convection is shown with curved segments with arrow heads.

The open flames 406 transfer heat with open flame radiation 408 and open flame convection 404. The open flame radiation 408 travels in all directions away from the open flames 406. Some of the heat from the open flame radiation 408 is transferred to the pan 100. The pan 100 transfers heat throughout the pan 100 with conduction. The pan 100 transfers heat with pan radiation 412 and pan convection 414. Some of the heat from the pan 100 is transferred to the solid food 400. The solid food 400 transfers heat throughout the food 400 with conduction. The solid food 400 transfers heat with solid food radiation 418 and solid food convection 416.

In the region between the open flames 406 and the pan 100 the heat transfers very inconsistently; in this region it is difficult to effectively warm food. The region between the pan 100 and the solid food 400 transfers heat very consistently; in this region it is easy to effectively warm food.

The pan 100 reduces fumes from the burning fuel from settling on the solid food 400 or liquid food. Sometimes a fuel such as wood may be coated with a substance such as paint, stain, or inks. It is very undesirable to have these substances settle on the solid food 400 as they will either taint the solid food 400 or make the solid food 400 inedible.

A desirable substance may be added to the inside of the pan 100 to intentionally cause fumes from the added substance to settle on the solid food 400 changing the flavor of the solid food 400.

The pan 100 may be designed such that at a designated temperature, the pan 100 changes shape. Example, but not limited to, is to use two different metals which expand at different rates when heated. At a low temperature the top of the pan 100 is closed and surrounds the solid food 400. After heating the pan 100 to a designated temperature, the pan 100 changes shape causing the top of the pan 100 to open, indicating that the solid food 400 is heated to its desired temperature. Another example is the pan 100 having a top structure and bottom structure secured together with a clip that changes shape at a designated temperature. After heating the pan 100 to a designated temperature, the clip changes shape, releasing the top structure of the pan 100 from the bottom structure of the pan 100.

The pan 100 and fork 118 may be designed such that as the fork 118 is rotated, the pan 100 stays stationary. As the fork 118 rotates, one or more tines 120 rotate to move the solid food toward and away from the pan 100 to control the heat transfer from the pan 100 to the solid food and to aid in removing the solid food from the fork 118. If a liquid is used in the pan 100, then as the fork 118 is rotated, the solid food is rotated into and out of the liquid.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A food warming device, comprising:
a fork, comprising:
a handle configured to reduce the conduction of heat;
one or more tines configured to hold solid food;
a pan, comprising:
a rigid metal structure configured to transfer heat from an open flame to solid food.

2. The food warming device as defined in claim 1, wherein the fork is held in the hand.

3. The food warming device as defined in claim 1, further where the pan is configured to be attached to the fork.

4. The food warming device as defined in claim 3, wherein the pan is detachable from the fork.

5. The food warming device as defined in claim 3, wherein the pan is foldable.

6. The food warming device as defined in claim 3, wherein the pan completely encloses the solid food.

7. The food warming device as defined in claim 6, wherein the pan opens when it reaches a threshold temperature.

8. The food warming device as defined in claim 3, fork rotates to move the solid food toward and away from the pan to control the heat transfer from the pan to the solid food and to aid in removing the solid food from the fork.

9. The food warming device as defined in claim 8, wherein the pan contains a liquid, and the food rotates into the liquid.

10. The food warming device as defined in claim 3, wherein the food stays stationary while the pan rotates towards and away from food.

11. The food warming device as defined in claim 1, wherein heat is transferred from the open flame to the food through convection.

12. The food warming device as defined in claim 1, wherein the pan has legs.

13. A method of warming food over an open flame, comprising:
Using a fork and a pan together to transfer heat from an open flame to a solid food.

14. The method defined in claim 13, wherein the fork rotates to move the solid food toward and away from the pan to control the heat transfer from the pan to the solid food and to aid in removing the solid food from the fork.

15. The method defined in claim 13, wherein the pan reduces fumes from the burning fuel from settling on the solid food.

16. The method defined in claim 13, wherein a substance is added to the inside of the pan to cause fumes from the added substance to settle on the solid food changing the flavor of the solid food.
